(19) United States
(12) Patent Application Publication
(10) Pub. No.: US 2024/0330483 A1
(43) Pub. Date: Oct. 3, 2024

(54) SYSTEM AND METHOD FOR DETERMINING CYBERSECURITY RISK LEVEL OF ELECTRONIC MESSAGES

(71) Applicant: Barracuda Networks, Inc., Campbell, CA (US)

(72) Inventors: Seyed Armin Seyeditabari, San Francisco, CA (US); Christopher L. Sawtelle, Santa Clara, CA (US)

(21) Appl. No.: 18/534,054

(22) Filed: Dec. 8, 2023

Related U.S. Application Data
(60) Provisional application No. 63/455,109, filed on Mar. 28, 2023.

(51) Int. Cl. G06F 21/57

(52) U.S. Cl. CPC G06F 21/577; G06F 2221/034

(57) ABSTRACT

A system includes an Internet Protocol (IP)/domain extraction unit configured to extract IP/domain data associated with a received electronic message. The system further includes a transmitter/receiver configured to transmit the extracted IP/domain to a database storing statistical data associated with a plurality of IPs/domains, and wherein the transmitter/receiver is configured to receive statistical data associated with the extracted IP/domain. The system also includes a contextual data analysis unit configured to generate context analysis data associated with a content of the received electronic message. A multimodal unit is configured to implement at least two sub-models configured to receive the statistical data and further configured to receive the context analysis data, wherein the multimodal unit is further configured to generate an output based on the statistical data and the context analysis data, and wherein the output is a cybersecurity threat associated with the received electronic message.

### CROSS-REFERENCE TO RELATED APPLICATIONS

This application claims the benefit and priority to the U.S. Provisional Patent Application No. 63/455,109, filed Mar. 28, 2023, which is incorporated herein in its entirety by reference.

### BACKGROUND

In today's digital age, organizations face a myriad of cybersecurity threats such as cyber-attacks launched from electronic messages in various types and formats. Phishing attack is a specific type of cyber-attack that has been on the rise wherein the sender of an electronic message masquerades as a trustworthy sender in an attempt to deceive the recipient into providing personal identity data or other sensitive information including but not limited to account usernames, passwords, social security number or other identification information, financial account credentials (such as credit card numbers) or other information, etc., to the sender by a return e-mail or similar electronic communication.

To prevent these attacks from resulting in significant financial losses, most email security systems use rule-based approaches. Unfortunately, rule-based approaches require manual updates to reflect new attacks and are often ineffective as new types of attacks emerge.

The foregoing examples of the related art and limitations related therewith are intended to be illustrative and not exclusive. Other limitations of the related art will become apparent upon a reading of the specification and a study of the drawings.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1B depict an example of a system configured to generate an output associated with cybersecurity threat utilizing machine learning (ML) models according to one aspect of the present embodiments.

FIG. 2 depicts an example of a multimodal unit according to one aspect of the present embodiments.

FIG. 3 is a relational node diagram depicting an example of a neural network for generating an ML model to determine a cybersecurity threat associated with an electronic message according to some embodiments.

FIG. 4 depicts a flowchart of an example of a process to determine a cybersecurity threat associated with an electronic message according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

It should also be understood that the terminology used herein is for the purpose of describing concepts, and the terminology is not intended to be limiting. Unless defined otherwise, all technical and scientific terms used herein have the same meaning as commonly understood by those skilled in the art to which the embodiment pertains.

Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that the singular forms of “a,” “an,” and “the” include plural references unless the context clearly dictates otherwise.

Some portions of the detailed descriptions that follow are presented in terms of procedures, methods, flows, logic blocks, processing, and other symbolic representations of operations performed on a computing device or a server. These descriptions are the means used by those skilled in the arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical, optical or magnetic signals capable of being stored, transferred, combined, compared, and otherwise manipulated in a computer system or computing device or a processor. These signals are sometimes referred to as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “storing,” “determining,” “sending,” “receiving,” “generating,” “creating,” “fetching,” “transmitting,” “facilitating,” “providing,” “forming,” “detecting,” “processing,” “updating,” “instantiating,” “identifying”, “contacting”, “gathering”, “accessing”, “utilizing”, “resolving”, “applying”, “displaying”, “requesting”, “monitoring”, “changing”, “extracting”, “classifying”, “aggregating”, “performing”, or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, hard drive, etc. Example embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, solid state drives, hard drives, hybrid drive, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

With the advancement of technology, Machine Learning (ML) has emerged as a valuable tool to help organizations filter out fraudulent emails before they even reach their intended recipients. This technology leverages modern machine learning techniques to combine multiple feature types, including text, header information, and statistical data about IP addresses and domains, to assess the validity of an electronic message (or message), which can be but is not limited to an email, a text message, an instant message, an online chat, a social media post, a voice message, etc. and to determine cybersecurity threats associated with the message. Additionally, the system continually updates its training dataset and statistical information to ensure it can accurately identify and flag potential cybersecurity threats. By utilizing the best machine learning models with up-to-date datasets, organizations can significantly enhance their electronic message security and reduce the risk of financial loss due to phishing, scams and attacks.

A new approach is proposed that uses a multimodal unit where a plurality of sub-models is used where each sub-model is used to process a particular data type/feature of a received electronic message. The multimodal unit uses the plurality of sub-models to generate an output that is associated with the cybersecurity threat of the electronic message that is being processed. For example, a first sub-model may utilize contextual data analysis to determine the context of content within an electronic message, e.g., an email. A second sub-model may be a tabular model that uses numerical input and categorical inputs, e.g., statistical data associated with a particular Internet Protocol (IP)/domain, tabular information from the header, etc., to categorize the electronic message. A third sub-model may utilize an inference engine to infer and identify an image within an electronic message. The number of sub-models may vary from one application to another. Regardless of the number of sub-models being used, the multimodal unit aggregates and categorizes the output from each sub-model in order to generate an output that is associated with the cybersecurity threat level of the electronic message. It is appreciated that the multimodal unit utilizes a number of different sub-models wherein each sub-model is utilized for processing a particular data feature (type), e.g., image, text, numerical, categorical, contextual, IP/domain statistics, etc., to improve the accuracy (or level) of the determination of whether an electronic message poses a cybersecurity threat.

Accordingly, the proposed multimodal unit may be used along with a number of sub-models, e.g., contextual representation of text, tabular features extracted from an electronic message and/or header, statistical data associated with the IP/domain of the electronic message, etc. The multimodal unit may include one or more transformer models to classify electronic messages not only based on its context, but also using additional information extracted from electronic message (e.g., image, statistical data associated with IP/domain, tabular data, etc.) to ensure high accuracy in identifying potential cybersecurity threats. It is appreciated that that data (e.g., statistical information) associated with electronic messages that are classified with a high level of accuracy may be provided and stored in a database for later retrieval to be used in subsequent cybersecurity threat analysis of other electronic messages, thereby keeping the IP and domain stats up-to-date. This ensures that the system stays current and can continue to identify potential threats accurately. In other words, the database continues to contain the most current statistical information about IP and domains present in the electronic message, which in turn improves the accuracy of the system's electronic message classification capabilities. The system's ability to continually update its database with the most recent information and its use of transformer models make it a highly effective tool for organizations looking to enhance their electronic message security measures.

As referred to hereinafter, electronic messages or messages include but are not limited to electronic mails or emails, text messages, instant messages, online chats on a social media platform, social media posts, voice messages or mails that are automatically converted to be in an electronic text format, or other forms of text-based electronic communications.

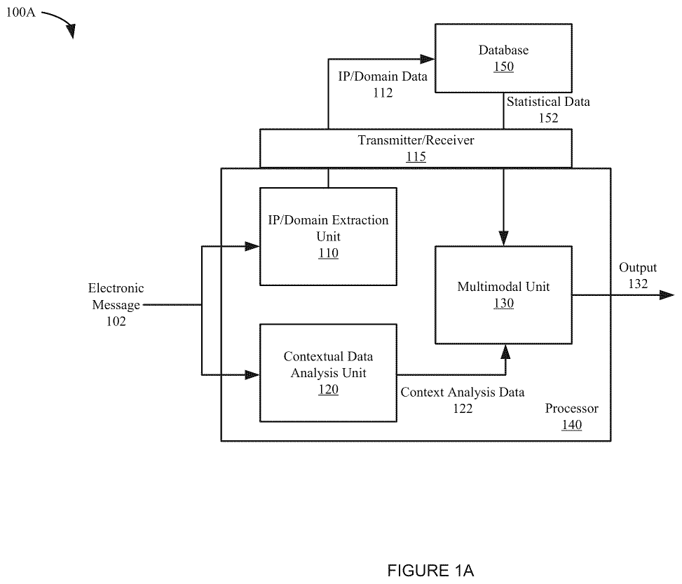

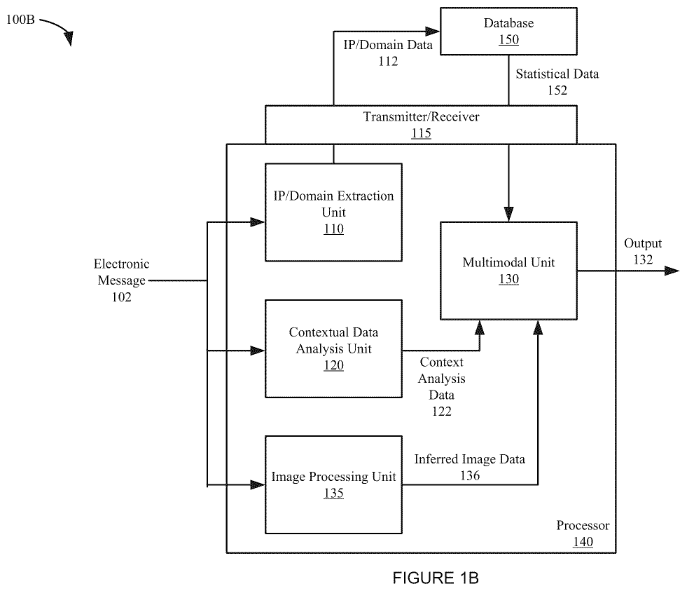

FIGS. 1A-1B depict an example of a system configured to generate an output associated with cybersecurity threat utilizing ML models according to one aspect of the present embodiments.

It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

Each of these components in the system 100A or 100B is/runs on one or more computing units/appliances/devices/hosts (not shown) each having one or more processors and software instructions stored in a storage unit such as a non-volatile memory of the computing unit for practicing one or more processes. When the software instructions are executed, at least a subset of the software instructions is loaded into memory (also referred to as primary memory) by one of the computing units, which becomes a special purposed one for practicing the processes. The processes may also be at least partially embodied in the computing units into which computer program code is loaded and/or executed, such that, the host becomes a special purpose computing unit for practicing the processes.

In the example of FIGS. 1A and 1B, each computing unit can be a computing device, a communication device, a storage device, or any computing device capable of running a software component. For non-limiting examples, a computing device can be but is not limited to a server machine, a laptop PC, a desktop PC, a tablet, a Google Android device, an iPhone, an iPad, and a voice-controlled speaker or controller. Each of these components in the system is associated with one or more communication networks (not shown), which can be but is not limited to, Internet, intranet, wide area network (WAN), local area network (LAN), wireless network, Bluetooth, Wi-Fi, and mobile communication network for communications among the engines. The physical connections of the communication networks and the communication protocols are well known to those skilled in the art.

In one nonlimiting example, the system 100A includes a processor 140. The processor 140 includes an IP/domain extraction unit 110, a contextual data analysis unit 120, a multimodal unit 130, and a transmitter/receiver 115. In some nonlimiting examples, an electronic message 102, e.g., an email, instant message, text message, online chat message, social media post, voice message, etc., is received by the processor 140. The IP/domain extraction unit 110 is configured to extract the IP/domain information associated with the electronic message 102 (e.g., sender's email domain). It is appreciated that the IP/domain that is extracted may be within the header of the electronic message and/or body of the electronic message (e.g., a link). The extracted IP/domain 112 may be transmitted via the transmitter/receiver 115 to a database 150. The database 150 stores statistical data, e.g., a number of times an IP address or email domain or URL domain has been associated with fraud within a certain period of time such as 10 days, 30 days, 90 days, etc., associated with one or more IP/domain. The statistical data may include IPv4 statistics, IPV6, IP protocol type, source TTL, source/destination addresses, subnet mask, default gateway, class of IP address (e.g., class A (with 3 octets for host allocation so that a single class A can have 17,777,214 hosts), B (with 2 octets so a single class B can have 65,534 hosts), C (with 1 octet so a single class C can have 254 hosts), D (reserved for multicast), E (reserved for experimental use)), public network, private network, etc.

If statistical data associated with the extracted IP/domain 112 is found within the database 150, then the statistical data 152 is sent to the processor 140, e.g., to the multimodal unit 130. The statistical data 152 may be used in a tabular model (i.e., sub-model) to categorize the electronic message, e.g., high cybersecurity threat, low cybersecurity threat, phishing electronic message, spam electronic message, etc. It is appreciated that in some embodiments, the statistical data 152 may be sent to the multimodal unit 130 as input to its corresponding sub-model or alternatively may be sent as an input to the IP/domain extraction unit 110 as input to the sub-model and where the output of the IP/domain extraction unit 110 is input to the multimodal unit 130.

It is appreciated that the content (e.g., body of the electronic message, the subject of the electronic message, etc.) of the electronic message 102 may be processed by the contextual data analysis unit 120. ML and Artificial Intelligence (AI) may be used to train and analyze the contextual data and to identify patterns, make predictions, or generate recommendations. Feeding the ML algorithm with contextual data alongside the primary data, the model learns to recognize and leverage the context for determining the level of cybersecurity threat associated with the electronic message. In some nonlimiting examples, a contextual model may be used as a sub-model to analyze the content of the electronic message 102 in order to determine the context of the electronic message. The contextual data analysis unit 120 generates the context analysis data 122 as its output, e.g., categorizing the electronic message such as phishing, spam, extortion, scamming, impersonation, etc.

In some nonlimiting examples, the contextual data analysis unit 120 may generate the context analysis data 122 using a natural language processing (NLP). In one nonlimiting example, the contextual data analysis unit 120 may use one or more transformer models to create a representation of the received electronic message 102. In one nonlimiting example, the context analysis unit 120 may use one or more ML models to perform text classification (classifying text into one of a predefined set of categories), text similarity (scoring how similar two or more pieces of texts such as sentences, paragraphs, documents, etc. are), text clustering (clustering several texts into groups of similar ones), keyword extractions (e.g., extracting salient keywords from a corpus of text), topic discovery (discovery of set of keywords that go together such as topics), etc.

The output of each sub-model (e.g., tabular model and contextual model) is input to the multimodal unit 130. The multimodal unit 130 aggregates and categorizes (e.g., by running a classification layer) the input to generate the output 132. The output 132 is associated with the level of cybersecurity threat. It is appreciated that if the accuracy of the cybersecurity threat of the output 132 exceeds a particular threshold, then the database 150 may be updated with the information associated with the electronic message 102, e.g., additional statistical data, statistical data associated with the IP/domain, etc., while output 132 that may not exceed the particular threshold may be stored in a separate database (not shown here) for later retrieval and assessment, e.g., by an analyst.

Referring now to FIG. 1B, system 100B according to some embodiments is shown. System 100B is similar to that of system 100A except that it includes an additional sub-model (i.e., image processing unit 135) that is configured to extract and identify image(s) within the electronic message 102. The inferred image data 136 (output of the sub-model) is input to the multimodal unit 130. As such, the multimodal unit 130 generates its output 132 also based on the inferred image data 136.

As illustrated in FIGS. 1A and 1B, when an electronic message is received various information from the electronic message is extracted, e.g., content, subject line, header, IP, etc. Additional information associated with the extracted information may be fetched from a database, e.g., statistical data as described above. Each extracted data is fed into its own corresponding sub-model, as described above to generate its own output (e.g., vector of numbers). The generated output from each sub-model may then be concatenated, e.g., using multimodal unit 130, to generate a representation for the received electronic message.

It is appreciated that the number of processing units (sub-models) is for illustration purposes only and should not be construed as limiting the scope of the embodiments, as illustrated by FIGS. 1A and 1B. Moreover, it is appreciated that while the units are shown within the processor 140, they may be implemented in more than one processing unit and in a distributed fashion.

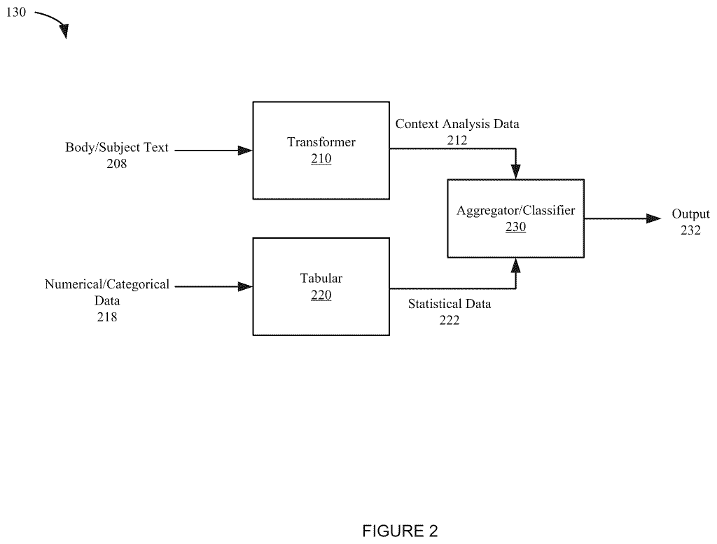

FIG. 2 depicts an example of a multimodal unit 130 according to one aspect of the present embodiments. In one nonlimiting example, the multimodal unit 130 may include a transformer 210 and a tabular 220 unit. The transformer 210 (a class of ML algorithm) may receive the body/subject text 208 for the electronic message 102, e.g., content of an email, subject line, etc. The transformer 210 creates a representation of the content to process the electronic message 102 for understanding its context, i.e., generating the context analysis data 212. In one nonlimiting example, the tabular 220 unit receives numerical/categorical data 218 associated with the electronic message 102. For example, the numerical/categorical data 218 may include statistical data associated with the IP/domain, number of words in the electronic message 102, time stamp of the electronic message 102, email header flags, reputation information for the IP address/email domain/URL in the email body, etc.. The tabular 220 unit may generate statistical data 222 from the input and/or may categorize the numerical data. The aggregator/classifier 230 may receive the output of each sub-model (two in this example). The aggregator/classifier 230 aggregates the information from a number of different sub-models and categorizes the final result as its output 232, e.g., level of cybersecurity threat associated with an electronic message. In some nonlimiting examples, additional sub-models may also be included, e.g., inferred image (similar to FIG. 1B). As such, the number of sub-models as input to the aggregator/classifier 230 is for illustration purposes only and should not be construed as limiting the scope of the embodiments.

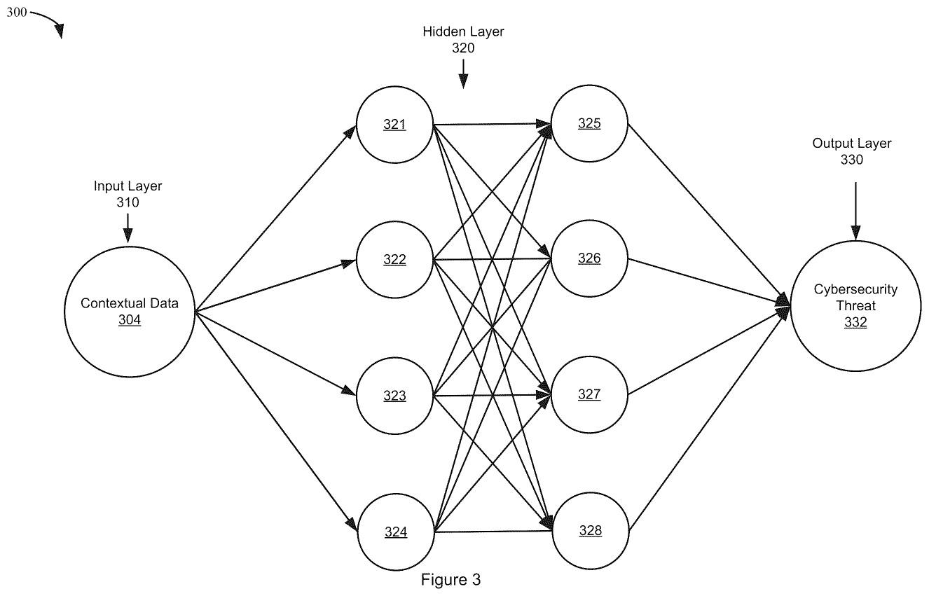

FIG. 3 is a relational node diagram depicting an example of a neural network for generating an ML sub-model for a cybersecurity threat associated with an electronic message according to some embodiments. It is appreciated that the relational node diagram is one nonlimiting example of a general neural network and that internal architecture of each sub-model may be more complex. Thus, the diagram is depicted for illustration purposes only. In an example embodiment, the neural network 300 utilizes an input layer 310, one or more hidden layers 320, and an output layer 330 to train the machine learning algorithm(s) or model to generate an ML model for determining a cybersecurity threat posed by an electronic message. In some embodiments, where the contextual data 304 (context of the received electronic message), as described above, has already been confirmed as well as the accuracy of determination of cybersecurity threat for the electronic message, supervised learning is used such that known input data, a weighted matrix, and known output data are used to gradually adjust the model to accurately compute the already known output. Once the model is trained, field data is applied as input to the model and a predicted output is generated. In other embodiments, where the accuracy of the determination of cybersecurity threat 332 level has not yet been confirmed, unstructured learning is used such that a model attempts to reconstruct known input data over time in order to learn. FIG. 3 is described as a structured learning model for depiction purposes and is not intended to be limiting.

Training of the neural network 300 using one or more training input matrices, a weight matrix, and one or more known outputs is initiated by one or more computers associated with the system. In an embodiment, a server may run known input data through a deep neural network in an attempt to compute a particular known output. For example, a server uses a first training input matrix and a default weight matrix to compute an output. If the output of the deep neural network does not match the corresponding known output of the first training input matrix, the server adjusts the weight matrix, such as by using stochastic gradient descent, to slowly adjust the weight matrix over time. The server computer then re-computes another output from the deep neural network with the input training matrix and the adjusted weight matrix. This process continues until the computer output matches the corresponding known output. The server computer then repeats this process for each training input dataset until a fully trained model is generated.

In the example of FIG. 3, the input layer 310 includes a plurality of training datasets that are stored as a plurality of training input matrices in a database associated with the system. The training input data includes, for example, contextual data 304. Any type of input data can be used to train the model.

In the embodiment of FIG. 3, hidden layers 320 represent various computational nodes 321, 322, 323, 324, 325, 326, 327, 328. The lines between each node 321, 322, 323, 324, 325, 326, 327, 328 represent weighted relationships based on the weight matrix. As discussed above, the weight of each line is adjusted overtime as the model is trained. While the embodiment of FIG. 3 features two hidden layers 320, the number of hidden layers is not intended to be limiting. For example, one hidden layer, three hidden layers, ten hidden layers, or any other number of hidden layers may be used for a standard or deep neural network. The example of FIG. 3 also features an output layer 330 with the level of cybersecurity threat 332 as the known output. As discussed above, in this structured model, the closeness determination of level of cybersecurity threat 332 is used as a target output for continuously adjusting the weighted relationships of the model. When the model successfully outputs the closeness determination of level of cybersecurity threat 332, then the model has been trained and may be used to process live or field data.

Once the neural network 300 of FIG. 3 is trained, the trained model will accept field data at the input layer 310, such as actual electronic message including content (e.g., text). In some embodiments, the field data is live data that is accumulated in real time. In other embodiments, the field data may be current data that has been saved in an associated database. The trained sub-model is applied to the field data in order to generate one or more level of cybersecurity threat posed by an electronic message. It is appreciated that FIG. 3 may be applicable to other input data to generate other sub-models. For example, the sub-model for statistical data (as described above) may similarly be generated. Moreover, the sub-model for images within an electronic message (as described above) may similarly be generated.

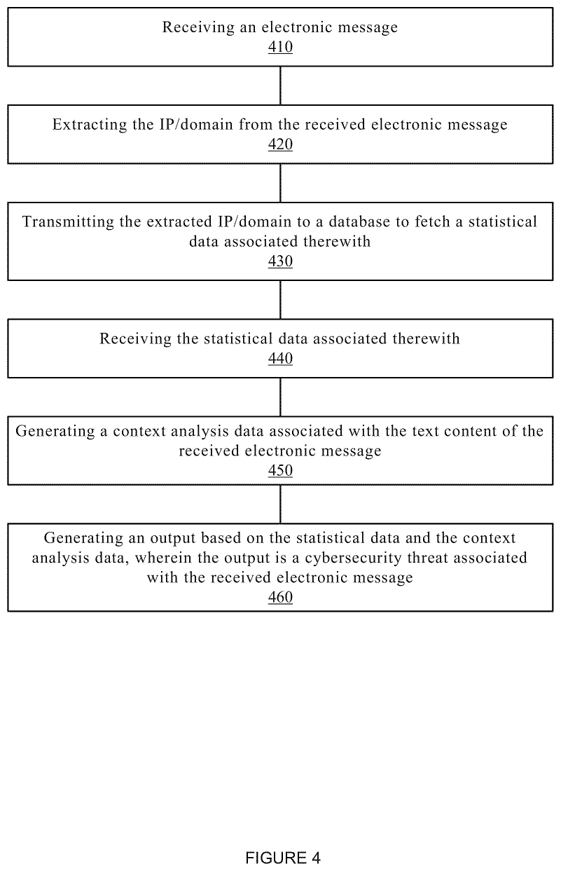

FIG. 4 depicts a flowchart of an example of a process to determine a cybersecurity threat associated with an electronic message according to one aspect of the present embodiments. At step 410, an electronic message is received, e.g., an email message, an instant message, a social media message, a social media post, etc., as described in FIGS. 1A-2. The received electronic message may have an IP/domain and a content associated therewith. At step 420, the IP/domain is extracted from the received electronic message, as described in FIGS. 1A-2. At step 430, the extracted IP/domain is transmitted to a database to fetch a statistical data associated therewith, as described in FIGS. 1A-2. At step 440, the statistical data associated with the extracted IP/domain is received, e.g., from the database, as described in FIGS. 1A-2. At step 450, a context analysis data associated with the text content of the received electronic message is generated, as described in FIGS. 1A-2, e.g., using NLP, generating a representation of the received electronic message, etc. For example, one or more of text classification, text similarity, text clustering, keywords extraction, and topics discovery to generate the context analysis data may be performed, as described above. At step 460, an output based on the statistical data and the context analysis data is generated. The output is a cybersecurity threat, e.g., phishing attack, spam, etc., associated with the received electronic message, as described in FIGS. 1A-2. It is appreciated that the output in some nonlimiting examples may be generated using an ML model.

It is appreciated that in one nonlimiting example, an image may be extracted from the received electronic message. The extracted image may be inferred and identified. The output at step 460 may be further based on the inferred image. In one nonlimiting example, the output at step 460 may be further based on a tabular model, as described in FIGS. 1A-2.

It is appreciated that the sub-models may be aggregated and classified to generate the output. In some optional embodiment, the data associated with the received electronic message may be stored in the database in response to accuracy of the output exceeding a threshold.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

What is claimed is:

1. A system, comprising:
an Internet Protocol (IP)/domain extraction unit configured to extract IP/domain data associated with a received electronic message;
a transmitter/receiver configured to transmit the extracted IP/domain to a database storing statistical data associated with a plurality of IPs/domains, and wherein the transmitter/receiver is configured to receive statistical data associated with the extracted IP/domain;
a contextual data analysis unit configured to generate context analysis data associated with a content of the received electronic message; and
a multimodal unit configured to implement at least two sub-models configured to receive the statistical data and further configured to receive the context analysis data, wherein the multimodal unit is further configured to generate an output based on the statistical data and the context analysis data, and wherein the output is a cybersecurity threat associated with the received electronic message.

2. The system of claim 1, wherein the contextual data analysis unit generates the context analysis data using a natural language processing.

3. The system of claim 1, wherein the generated context analysis data is a category associated with the received electronic message.

4. The system of claim 1 further comprising an image extraction unit and an image processing unit, wherein the image extraction unit is configured to extract an image within the received electronic message and wherein the image processing unit is configured to identify the extracted image, and wherein the multimodal unit is further configured to generate the output based on the identified extracted image.

5. The system of claim 1, wherein the contextual data analysis unit uses at least one transformer model that is configured to create a representation of the received electronic message.

6. The system of claim 1, wherein the multimodal unit comprises a tabular model as one sub-model and wherein the multimodal unit is further configured to generate the output based on the tabular model.

7. The system of claim 1, wherein the multimodal unit comprises an aggregator/classifier unit configured to generate the output from the at least two sub-models by running a classification layer.

8. The system of claim 1, wherein the multimodal unit is further configured to store data associated with the received electronic message in the database in response to accuracy of the output exceeding a threshold.

9. The system of claim 1, wherein the cybersecurity threat is one of a phishing attack or spam.

10. The system of claim 1, wherein the received electronic message is one of an email message, an instant message, a social media message, or a social media post.

11. The system of claim 1, wherein the contextual data analysis unit uses machine learning (ML) and wherein the contextual data analysis unit performs text classification, text similarity, text clustering, keywords extraction, and topics discovery to generate the context analysis data.

12. The system of claim 1, wherein the multimodal unit applies a machine learning (ML) model to generate the output.

13. A method comprising:
receiving an electronic message, wherein the received electronic message has an Internet Protocol (IP)/domain and a text content associated therewith;
extracting the IP/domain from the received electronic message;
transmitting the extracted IP/domain to a database to fetch a statistical data associated therewith;
receiving the statistical data associated therewith;
generating a context analysis data associated with the text content of the received electronic message; and
generating an output based on the statistical data and the context analysis data, wherein the output is a cybersecurity threat associated with the received electronic message.

14. The method of claim 13 further comprising performing a natural language processing on the content of the received data to generate the context analysis data.

15. The method of claim 13 further comprising:
extracting an image within the received electronic message; and
identifying the extracted image, and wherein the output is further generated based on the identified extracted image.

16. The method of claim 13 further comprising creating a representation of the received electronic message to generate the context analysis data.

17. The method of claim 13 further comprising generating the output further based on a tabular model.

18. The method of claim 13 further comprising performing classification and aggregation on the context analysis data and the statistical data to generate the output.

19. The method of claim 13 further comprising storing data associated with the received electronic message in the database in response to accuracy of the output exceeding a threshold.

20. The method of claim 13, wherein the cybersecurity threat is one of a phishing attack or spam.

21. The method of claim 13, wherein the received electronic message is one of an email message, an instant message, a social media message, or a social media post.

22. The method of claim 13 further comprising performing text classification, text similarity, text clustering, keywords extraction, and topics discovery to generate the context analysis data.

23. The method of claim 13, wherein generating the output is based on application of a machine learning (ML) model.
